(19) United States
(12) Patent Application Publication
(10) Pub. No.: US 2026/0021708 A1
(43) Pub. Date: Jan. 22, 2026

(54) Excavator with Electric Plug-In

(71) Applicant: Michael Maggio, Catheys Valley, CA (US)

(72) Inventor: Michael Maggio, Catheys Valley, CA (US)

(21) Appl. No.: 18/777,336

(22) Filed: Jul. 18, 2024

(51) Int. Cl. B60L 9/00; E02F 3/32; E02F 3/76; E02F 9/20; E02F 9/22; E21B 3/02

(52) U.S. Cl. CPC B60L 9/00; E02F 3/32; E02F 3/7609; E02F 9/2095; E02F 9/22; E21B 3/022; B60L 2200/40; E02F 9/207

(57) ABSTRACT

The device is an excavator with electric plug-in capability. An electric power source of conventional power or a generator is attached to an electric motor on the excavator by a power cord. The electric motor activates a hydraulic pump, which in turn operates a boom with a bucket, a leveling blade, a drill, or an auger. Alternatively, an electric motor with a hydraulic pump are at a remote location and connected by a power cord and a hose to the excavator.

### FIELD OF INVENTION

The application relates to an excavator with electric plug-in capability.

### BACKGROUND OF INVENTION

An excavator is a heavy construction machine, comprising a boom, a bucket, or a drill, and a cab on a carriage which has the ability to move. The excavator is used to dig into and then remove soil and materials. Some excavator's are used to break-up existing concrete flooring in buildings, where concrete and steel reinforced flooring is projected to be installed to replace the existing flooring, as occurs when a building has been re-purposed, or for earthquake retrofitting, for demolition, or due to structural damage to the building.

The Chinese have protected the utility of their construction machines relying on plug-in electric power in related fields such as Hao Bingun, CN207620733U which teaches a long spiral drilling rig. It discloses an auger drilling machine attached to an electric power cord. It identifies the problem the invention is trying to solve as: “ . . . with the gradual concentration of urban construction, the setting depth of foundation pit excavation is continuously increased, the pile diameter and the pile length of a slope protection pile are increased, and a long spiral drilling machine is generally used for drilling.” Similarly, Zhang Wenyan, CN103924918A teaches an ultra-deep drilling rig with an electric motor and power cord connected to a generator.

In the USA, Juha Piipponen in U.S. Pat. No. 8,660,760 discloses a mining drill with electric plug-in for power. In Europe, Sandvik Mining in EP 2955316A1 discloses a rock drill with electric plug-in. None of the prior art relates to an excavator, typically engaged in renovation of buildings, and here involving indoor work. On construction sites, electric power is readily available. The advantages of plug-in power sources are the excavator is able to work continuously without interruption for refueling, and the power source is ecologically sound.

In one embodiment of an excavator with electric plug-in, an existing power diesel, gas, or propane power plant is removed, and replaced with an electric motor. The purpose of the electric motor is to move the excavator and its boom, bucket, auger, or drill. The replacement electric motor is compatible with the removed power plant in terms of horsepower and ability to generate torque. The electric motor has a hydraulic coupler attached to the existing pump to control the operation of the boom, bucket or drill. And the switches and gauges are modified as necessary to monitor performance of the excavator. Further, there is no disposal of unnecessary batteries.

In another embodiment of the excavator with electric plug-in, the remotely located electric motor works over the hydraulic pump with hydraulic hoses. A quick connect coupler allows attachment of the hoses to the excavator. And the switches and gauges are modified as necessary to monitor performance of the excavator under electric power. The electric motor can be 208/230/460/796 volts. Other embodiments are possible as understood by a person having ordinary skill in the arts and are included in the design of this invention.

### BRIEF DESCRIPTION OF DRAWINGS

FIG. 1 is a side view of the excavator with electric plug-in, where the existing diesel, gas, or propane power plant has been removed.

FIG. 2 is a top view of the excavator with electric plug-in, where the existing diesel, gas, or propane power plant has been removed.

FIG. 3 is a side view of the excavator with electric plug-in, where the electric motor works over the hydraulic pump with hydraulic hoses.

### DETAILED DESCRIPTION OF THE INVENTION

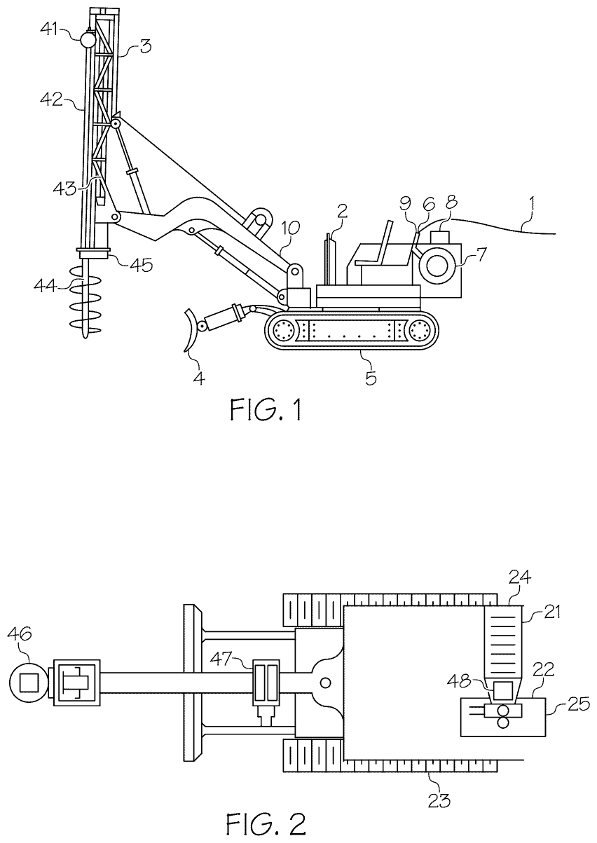

In FIG. 1 an electric power supply system [6] is connected to an excavator [5] by a power cord [1]. The power cord [1] which is inserted into a power outlet [9], can be of any convenient length, for instance 200 feet, to allow the excavator [5] to operate inside a building which is undergoing renovation for strengthening the flooring, for earthquake retrofitting, to repair structural damage to the building, and/or for demolition. The power cord [1] can be wound around a spool [8] for storing when not in use. The electric power supply system [6] provides electric current to operate the electric motor [7], which is located in the same position where a diesel, gas, or propane power plant was removed [and is not shown]. In turn, the electric motor [7] activates the on board hydraulic pump causing hydraulic fluid to flow through hoses, which hydraulic fluid is the lifeblood of all movement by the excavator. The hydraulic fluid powers a boom [10], a blade for leveling [4], a drill [3], or an auger [44]. The components of the boom [10] include: a top drive [41] which is a high-power gyrator that determines the speed of drill bit; a Kelly bar [42] which can increase the depth of the hole; a drilling shaft [43]; and, a base drive [45] to move the boom. The switches and gauges [2] have been replaced. For instance, instead of a gauge reading mileage for the diesel, gas, or propane power plant, a replacement gauge will read in hours of operation. Also, instead of a gauge indicating amount of fuel remaining, the replacement gauge would indicate level of charge. Gauges for torque on power directed to operate the drill [3] or the blade for leveling [4], reading in revolutions per minute will be the same for the excavator with electric plug-in.

In FIG. 2 a top view reveals the aft location of the electric motor [21], the hydraulic pump [22], and the hydraulic fluid tank [25], for the excavator [23]. The electric motor [21] will provide power for the hydraulic pump [22] in the same manner as was performed by the diesel, gas, or propane power plant that was removed. The power outlet [24] for the power cord provides a source of electric power to the excavator [23].

The location of the adapter to convert electric power to the hydraulic pump [48] is shown. A top view of a top head drive [46] and of a wench [47] is shown.

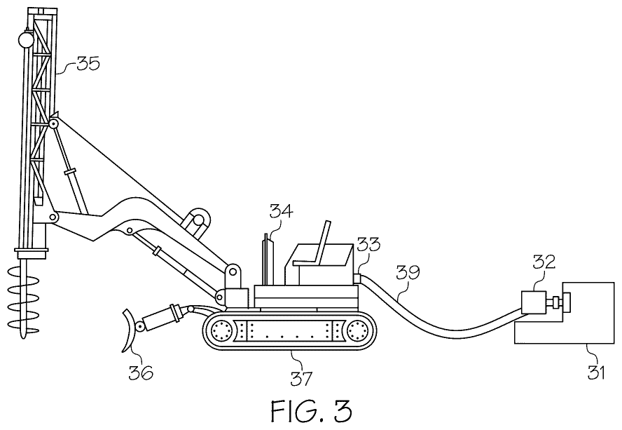

In FIG. 3 another embodiment of the excavator [37] is disclosed. An electric motor over hydraulic pump [32] is remotely located at a source of electric power [31]. The hydraulic pump [32] which is located on board the excavator [37] is connected by a quick connect coupler [33] to a hose [39]. When the electric motor is activated, the pump pushes hydraulic fluid to the excavator [37], to operate the drill [35] or the leveling blade [36]. The switches and gauges [34] accommodate electrical operation. The hose [39] is stored when not in use near the source of electric power [31], instead of being stored on the excavator.

In an embodiment, the excavator with electric plug-in, comprises an electric motor, which is connected by a power cord to a remote source of electric power, with a hydraulic coupler attached to a hydraulic pump, where the remote source of electric power gives the excavator the capability to move and to operate a boom, with a bucket, a leveling blade, a drill, or an auger.

The excavator with electric plug-in, comprises an electric motor, which is connected by a power cord to a remote source of electric power with a hydraulic coupler attached to a hydraulic pump, and, the remote source of electric power gives the excavator the capability to move and to operate a boom with a bucket, a drill, a leveling blade, or an auger. And the excavator may be used in demolition operations with substitute tools. Alternatively, the excavator with electric plug-in, comprises a remote electrically driven motor controlling a hydraulic system, which is connected by a hose with a quick connect coupler on board, and the remote source of electric motor over the hydraulic pump gives the excavator the capability to move and to operate a boom with a bucket. Or, the remote source of electric over hydraulic power gives the excavator the capability to move and to operate a boom with a drill, or any of the other tools.

In another embodiment, the excavator with electric plug-in, comprises a remote electrically driven motor controlling a hydraulic system, which is connected by a hose with a quick connect coupler on board, where the remote source of electric over hydraulic power gives the excavator the capability to move and to operate a boom, with a bucket, a leveling blade, a drill, or an auger. The hydraulic system comprises a hydraulic pump, which is connected to a hydraulic fluid tank, and connected to a first end of a hydraulic hose, where a second end of the hydraulic hose is connected to the excavator. Other embodiments as may be developed by a person of ordinary skill in the art, with non-material changes to the foregoing disclosure are included in this application.

I claim:

1. An excavator with electric plug-in, comprising:
an electric motor,
which is connected by a power cord to a remote source of electric power with a hydraulic coupler attached to a hydraulic pump,
where the remote source of electric power gives the excavator the capability to move and to operate a boom with a bucket.

2. The excavator in claim 1 where the remote source of electric power gives the excavator the capability to move and to operate the boom with a drill.

3. The excavator in claim 1 where the remote source of electric power gives the excavator the capability to move and to operate the boom with an auger.

4. The excavator in claim 1 where the remote source of electric power gives the excavator the capability to move and to operate the boom with a leveling blade.

5. The excavator in claim 1 where the remote source of electric power gives the excavator the capability to move and to operate the boom with demolition attachments.

6. An excavator with electric plug-in, comprising:
a remote electrically driven motor controlling a hydraulic system,
which is connected by a hose with a quick connect coupler on board,
where the remote source of electric motor over the hydraulic pump gives the excavator the capability to move and to operate a boom with a bucket.

7. The excavator in claim 6 where the remote source of electric over hydraulic power gives the excavator the capability to move and to operate the boom with a drill.

8. The excavator in claim 6 where the remote source of electric over hydraulic power gives the excavator the capability to move and to operate the boom with an auger.

9. The excavator in claim 6 where the remote source of electric over hydraulic power gives the excavator the capability to move and to operate the boom with a leveling blade.
